(19) United States
(12) Patent Application Publication
(10) Pub. No.: US 2006/0032764 A1
(43) Pub. Date: Feb. 16, 2006

(54) Gift card and recordable optical disk kit with matching artwork

(75) Inventor: Steven C. Swenson, Champlin, MN (US)

Correspondence Address: Imation Corp., PO Box 64898, St. Paul, MN, 55164-1450, US

(73) Assignee: Imation Corp.

(21) Appl. No.: 10/917,228

(22) Filed: Aug. 11, 2004

(51) Int. Cl. B65D 71/00; B42D 15/00; B65D 85/30; G09F 1/00

(52) U.S. Cl. 206/232; 206/308.1; 229/92.8; 40/124.06

(57) ABSTRACT

In general, the invention is directed to gift card kits. Gift card kits include gift cards and recordable media, wherein artwork pre-printed on a recordable medium substantially matches artwork printed on the gift card. Gift card kits may additionally include gift certificates for purchasing digital content, which may then by recorded onto the recordable medium. The invention is also directed to methods for using the gift card kits. A gift card kit allows a purchaser to place unique digital content onto a recordable medium and include the recorded medium with a gift card for an aesthetically pleasing and thoughtful gift.

### TECHNICAL FIELD

The invention relates to the field of gift cards and, in particular, individually customizable gift cards.

### BACKGROUND

This invention is directed to gift cards, including birthday cards, Christmas cards and the like. Gift cards are a primary means to express sentiment and celebrate a variety of events. Gift cards are currently available in a variety of formats including paper and digital formats.

### SUMMARY

In general, the invention combines a gift card with a recordable optical media to define a gift card kit. In particular, gift card kits are described that comprise a gift card and a recordable medium, wherein artwork pre-printed on a recordable medium substantially matches artwork printed on the gift card. Also described are methods for using the described gift card kits. The described gift card kits allow a gift giver to place unique digital content onto a recordable medium and include the recorded medium with a gift card for an aesthetically pleasing gift.

In one embodiment, the invention is directed to a gift card kit comprising a gift card including first artwork printed on the gift card and a recordable optical medium including second artwork printed on the recordable optical medium. The first artwork substantially matches the second artwork. Furthermore, a gift giver can record one or more items onto the recordable optical medium and give the gift card and recordable optical medium to a recipient.

In another embodiment, the invention is directed to a gift card kit comprising a gift card, a recordable optical medium, and an insert including a number or code that entitles a free download of an item. The gift card includes a first artwork printed on the gift card. The recordable optical medium includes a second artwork printed on the recordable optical medium, and the first artwork substantially matches the second artwork. A recipient of the gift card kit can download the item using the number and record the item onto the recordable optical medium. The insert that includes the number or code may also include third artwork printed thereon, which substantially matches the first and second artwork.

In a different embodiment, the invention is directed to a method that may be executed by a purchaser of the gift card kit. The method may comprise purchasing a gift card kit, recording one or more items on the recordable optical medium for a recipient, and giving the gift card to the recipient with the recordable optical medium. The gift card kit comprises a gift card including first artwork printed on the gift card, and a recordable optical medium including second artwork printed on the recordable optical medium.

The details of one or more embodiments of the invention are set forth above and in the accompanying drawings and the description below. Other features, objects, and advantages of the invention will be apparent from the description and drawings, and from the claims.

### BRIEF DESCRIPTION OF DRAWINGS

FIG. 1 depicts a gift card kit according to an embodiment of the invention.

FIG. 2 depicts a pre-printed recordable optical media and matching preprinted gift card according to an embodiment of the invention.

FIG. 3 depicts the front and the inside of a preprinted gift card and matching preprinted recordable optical media according to an embodiment of the invention.

FIG. 4 depicts the front and the inside of a preprinted gift card and includes a recordable optical media, preprinted to match the gift card, according to an embodiment of the invention.

FIG. 5 depicts the front and the inside of another preprinted gift card and includes a pre-printed recordable optical media fixed under tabs in the gift card according to an embodiment of the invention.

FIG. 6 is a flow diagram illustrating a method for using a gift card kit according to an embodiment of the invention.

### DETAILED DESCRIPTION

Generally, the invention is directed to a gift card kit, wherein the gift card kit includes a preprinted gift card and a recordable optical medium. The recordable optical medium is screen-printed with artwork that substantially matches artwork preprinted onto the gift card. For example, the artwork of the gift card and the medium may be identical, complimentary, or generally related to a common theme in the spirit of gift giving. In other embodiments the invention relates to a method of using the gift card kit.

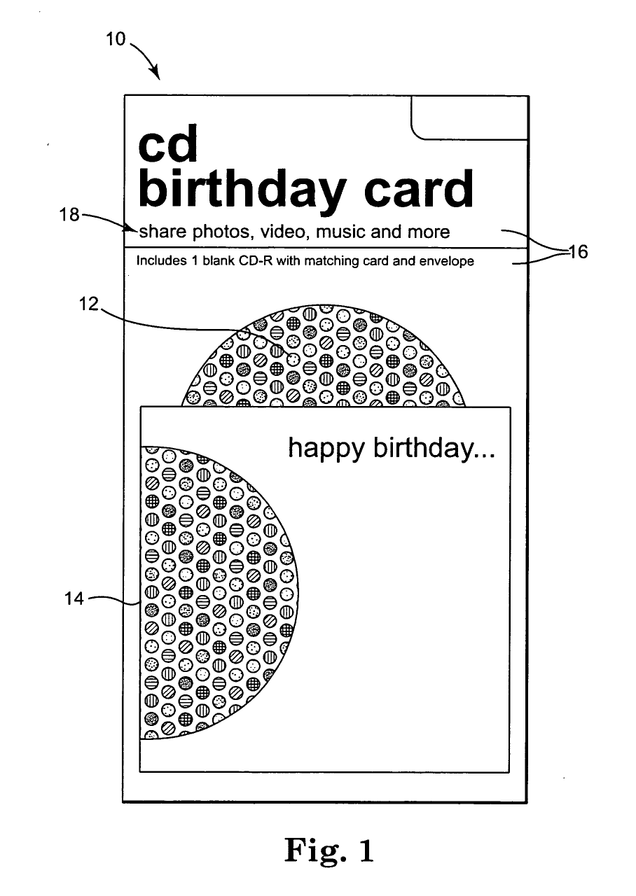

FIG. 1 depicts gift card kit 10 according to an embodiment of the invention. Gift card kit 10 includes an advertising insert 16, a blank screen-printed CD-R 12, and a matching preprinted gift card 14. An envelope may also be included in the kit, and possibly other items such as a coupon or gift certificate. Gift card kit 10 may additionally comprise a clear plastic wrapping to hold advertising insert 16, CD-R 12, and gift card 14 together. In accordance with the invention, the preprinted artwork on gift card 14 substantially matches the preprinted artwork on preprinted CD-R 12. For example, artwork may be silk-screened onto CD-R 12. While gift card kit 10 includes blank CD-R 12, other embodiments may include different forms of recordable optical media, like rewriteable CDs (CD-RWs) or DVD-Rs. Alternatively, other recordable media such as recordable FLASH memory may be used, although recordable optical media are preferred.

As a new product, gift card kit 10 will be unfamiliar to potential purchasers. The gift card kit may be displayed near conventional gift cards, near recordable media or as part of a stand-alone promotional display. However, no matter where the gift card kit is displayed, potential buyers must be informed as to the utility of gift card kit 10 before they would be willing to purchase it. Advertising insert 16 comprises notice 18, which states, “Share photos, video, music and more. Includes 1 blank CD-R with matching card and envelope.” Advertising insert 16, including notice 18, informs buyers of the content and utility of gift card kit 10. Advertising insert 16 may additionally comprise instructions that inform the purchaser how to put digital content on CD-R 12. In other embodiments, different packaging materials, like a box, for example, may serve the purpose of informing a potential buyer of the utility of a gift card kit. Importantly, insert 18 includes a conspicuous notice that informs potential buyers of the content and/or purpose of kit 10.

Gift card kit 10 may additionally comprise an insert that includes purchaser instructions for recording media onto the CD-R, and attaching the CD-R to the preprinted gift card. The insert may also have artwork that substantially matches that of CD-R 12 and gift card 14. In some embodiments, gift card kit 10 may also include a gift certificate, e.g., with a code or number that entitles the purchaser or the recipient to download music, video, pictures or other digital information from an Internet website. For example, gift card kit 10 may include a gift certificate redeemable at Napster, iTues, or a similar on-line music site. In embodiments that include such a gift certificate for downloading digital information, gift card kit 10 may additionally comprise instructions for redeeming the gift certificate and recording information received from the redeemed gift certificate onto the CD-R. For example, such instructions may be preprinted on insert 16 or a gift certificate (not shown). The gift certificate, instructions, or any other insert may be printed with artwork that substantially matches that of CD-R 12 and gift card 14 in order to present a visually pleasing product to purchasers browsing a gift card aisle of a retail establishment.

Although gift card kit 10 is illustrated as including a single preprinted gift card and a single preprinted CD-R with substantially matching artwork, in other embodiments, a gift card kit may comprise multiple gift cards and recordable optical media sets. For example, there may be five gift cards and five recordable optical media included in a single gift card kit. A gift card kit comprising multiple gift cards and recordable optical media may allow a purchaser to record identical digital content onto multiple recordable optical media with reduced effort. Each gift card kit comprising multiple gift cards and multiple recordable optical media may have different artwork designs for each preprinted gift card and substantially matching recordable optical media. In other embodiments, all recordable optical media and gift cards in a gift card kit may have substantially matching artwork.

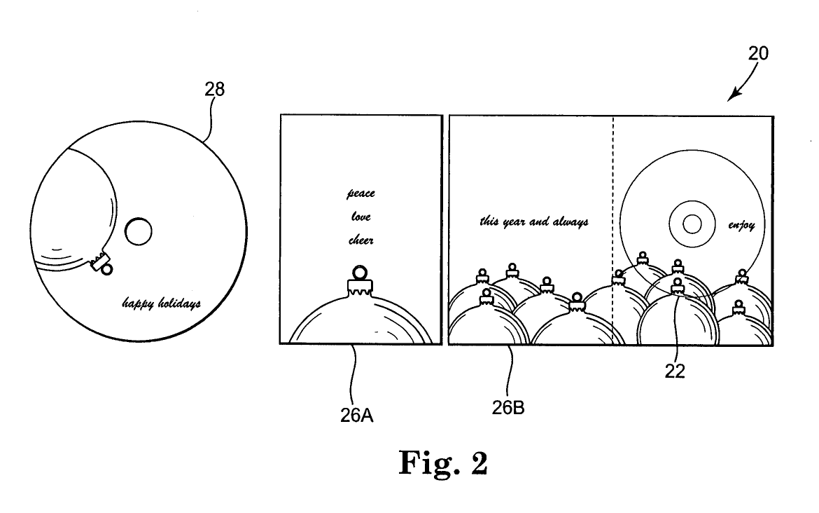

FIG. 2 depicts a pre-printed recordable optical medium 28 and matching preprinted gift card 26 (outside view is labeled 26A and inside view is labeled 26B) according to an embodiment of the invention. Preprinted artwork depicting Christmas tree ornaments appears on the outside view 26A and inside view 26B of gift card 26. Substantially matching artwork appears on recordable optical medium 28. While artwork on gift card 26 and recordable optical medium 28 substantially matches, it is not necessarily identical. In this case, the artwork is complimentary and generally related to a common theme in the spirit of Christmas gift giving. The artwork on gift card 26 and recordable optical medium 28 may also include holiday greetings, similar to what one might find on a conventional gift card.

In the embodiment of the invention depicted in FIG. 2, the inner surface of gift card 26 includes an outline 22 showing where a gift giver should attach recordable optical medium 28 before giving it to a recipient. The gift card kit may additionally comprise instructions for attaching recordable optical medium 28 to gift card 26. Such instructions may instruct the purchaser to attach recordable optical media using tape. Additionally, gift card 26 may include an adhesive for the purchaser to attach recordable optical medium 28. The adhesive may be attached to gift card 26 with a removable backing to prevent the adhesive from sticking to other parts of gift card 26. In a different embodiment, gift card 26 may comprise a sleeve, allowing the purchaser to slide optical medium 28 into the sleeve to facilitate giving gift card 26 and optical medium 28 as a single package. In other cases, gift card 26 may allow a purchaser to include recordable optical medium 28 with gift card 26 by other means, such as tabs or the like.

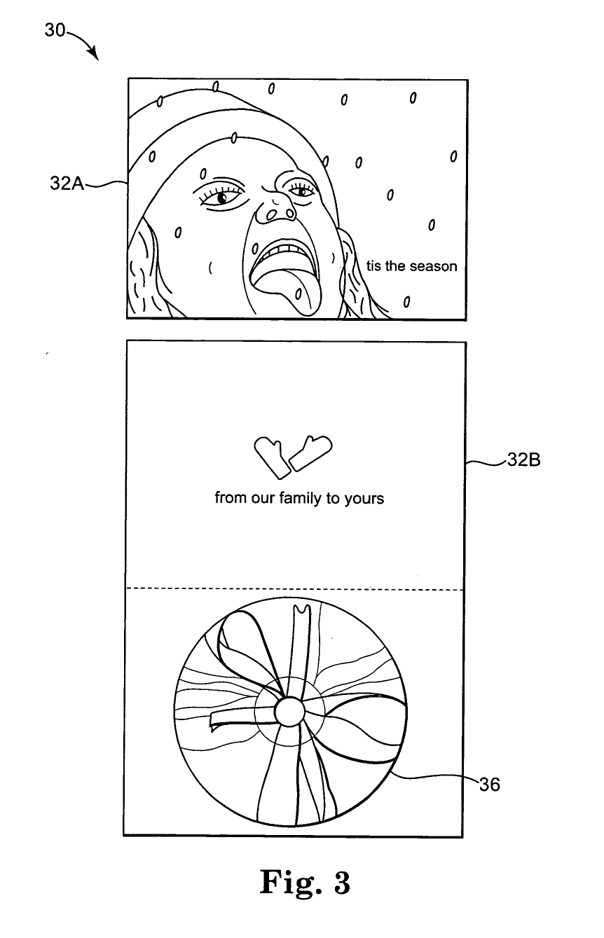

FIG. 3 depicts the front and the inside of a preprinted gift card 32 (outside view is labeled 32A and inside view is labeled 32B) and matching preprinted recordable optical medium 36 according to an embodiment of the invention. Gift card kit 30 comprises preprinted gift card 32, matching preprinted recordable optical medium 36 and an envelope (not shown). Preprinted gift card 32 comprises artwork that substantially matches artwork preprinted on recordable optical medium 36. Inside view 32B of a gift card also comprises artwork that substantially matches recordable optical medium 36. In particular, the artwork on gift card 32 and medium 36 is generally complimentary and representative of a gift-giving season. For example, gift card 32 is printed with a little girl catching snowflakes and medium 36 includes a bowtie. Thus, both medium 36 and gift card 32 include artwork indicative of a winter gift-giving season, such as the Christmas season. Colors may also match. As opposed to the embodiment depicted in FIG. 2, gift card kit 30 does not include a means to attach recordable optical medium 36 to gift card 32. Instead, gift card 32 is large enough when folded to fully cover recordable optical medium 36. The purchaser may then include recordable optical medium 36 by simply placing recordable optical medium 36 in gift card 32 and placing both in the matching envelope.

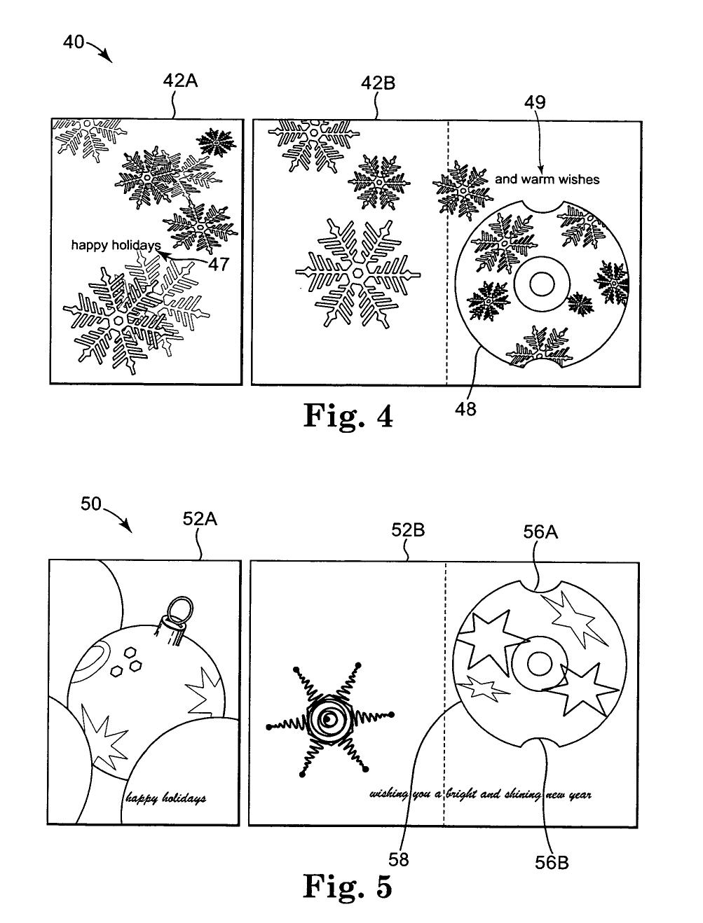

FIG. 4 depicts the front and the inside of a preprinted gift card 42 (outside view is labeled 42A and inside view is labeled 42B) and includes a recordable optical medium 48, preprinted to match the gift card 42, according to an embodiment of the invention. Gift card kit 40 comprises gift card 42 and recordable optical medium 48. Preprinted artwork on gift card 42 substantially matches preprinted artwork on recordable optical medium 48. In this embodiment, inside view 42B of gift card 42 includes a holiday greeting 49. The outside view 42A of gift card 42 includes another greeting 47. However, in contrast to the embodiment of FIG. 2, recordable optical medium 48 does not also include a preprinted greeting. Instead, optical medium 48 is printed with snowflakes that substantially match those on the outer surface of gift card 42.

FIG. 5 depicts a front view 52A and an inside view 52B of preprinted gift card 52 and includes a pre-printed recordable optical medium 58 fixed under tabs 56A and 56B (collectively “tabs 56”) according to an embodiment of the invention. The depicted gift card kit 50 is of the same design as gift card kit 40 in FIG. 4, except that the artwork in FIG. 4 is different from the artwork in FIG. 5. In this embodiment of the invention, recordable optical medium 58 is attached to gift card 52 using tabs 56. Gift card 52 may additionally comprise instructions for a purchaser to attach recordable optical medium 58 to gift card 52 using tabs 56.

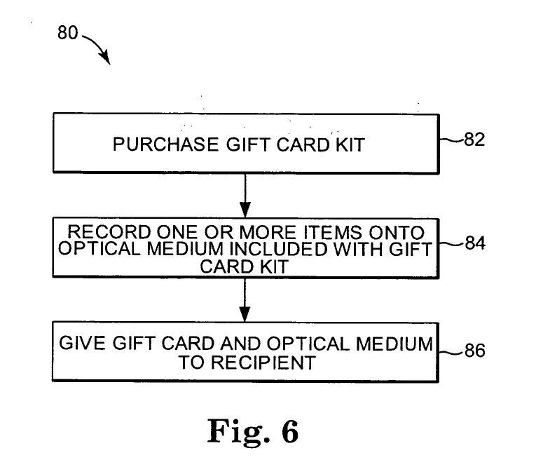

FIG. 6 is a flow diagram illustrating a method 80 for using a gift card kit according to an embodiment of the invention. Generally, a purchaser or gift giver would perform method 80, although the invention is not necessarily limited in that respect as more than one individual could also perform the various steps of method 80. Method 80 comprises purchasing a gift card kit (82), recording one or more items onto a recordable optical medium included with the gift card kit (84), and giving a gift card included with the gift card kit with the purchaser-recorded optical medium (86). For example, the one or more items may include songs, photographs, or video clips. The items can be selected specifically for the gift recipient and may have personal meaning to that person. Method 80 may additionally comprise following directions, which may be included with the gift card kit. In some embodiments, the recordable optical medium may be a CD-R, a DVD-R, or a CD-RW.

Various embodiments of the invention have been described. These and other embodiments are within the scope of the following claims.

1. A gift card kit comprising:
a gift card including first artwork printed on the gift card; and
a recordable optical medium including second artwork printed on the recordable optical medium, wherein the first artwork substantially matches the second artwork and wherein a gift giver can record one or more items onto the recordable optical medium and give the gift card and recordable optical medium to a recipient.

2. The gift card kit of claim 1, wherein the gift card includes a sleeve to receive the recordable optical medium.

3. The gift card kit of claim 1, wherein the recordable optical medium comprises a CD-R disk.

4. The gift card kit of claim 1, wherein the recordable optical medium comprises a recordable DVD disk.

5. The gift card kit of claim 1, wherein the items comprise songs selected by the gift giver for the recipient.

6. The gift card kit of claim 1, wherein the items comprise pictures selected by the gift giver for the recipient.

7. The gift card kit of claim 1, wherein the items comprise video clips selected by the gift giver for the recipient.

8. The gift card kit of claim 1, further comprising packaging materials to package the gift card with the recordable optical medium for purchase by the gift giver.

9. The gift card kit of claim 8, wherein packaging materials include conspicuous instructions indicating that the gift giver can record one or more items onto the recordable optical medium and give the gift card and recordable optical medium to the recipient.

10. The gift card kit of claim 1, wherein the recordable optical medium is silk-screened with the second artwork.

11. The gift card kit of claim 1, wherein the gift card includes a tab to attach the recordable optical medium to the gift card.

12. A gift card kit comprising:
a gift card including first artwork printed on the gift card;
a recordable optical medium including second artwork printed on the recordable optical medium, wherein the first artwork substantially matches the second artwork; and
an insert including a number that entitles a free download of an item, wherein a recipient of the gift card kit can download the item using the number and record the item onto the recordable optical medium.

13. The gift card kit of claim 12, wherein the insert includes third artwork that substantially matches the first and second artwork.

14. A method comprising:
purchasing a gift card kit comprising a gift card including first artwork printed on the gift card, and a recordable optical medium including second artwork printed on the recordable optical medium;
recording one or more items on the recordable optical medium for a recipient; and
giving the gift card to the recipient with the recordable optical medium.

15. The method of claim 14, wherein the gift card kit includes an advertising insert printed with conspicuous directions, wherein recording the one or more items and giving the gift card comprise following the directions.

16. The method of claim 14, wherein recording the one or more items comprises recording at least one from a group consisting of a song, a photograph and a video clip.
